(19) United States
(12) Patent Application Publication
(10) Pub. No.: US 2015/0181437 A1
(43) Pub. Date: Jun. 25, 2015

(54) System and Method for Reception Adaption to Reduce Transmission Interference in a Device That Implements More Than One Wireless Technology

(71) Applicant: Broadcom Corporation, Irvine, CA (US)

(72) Inventors: Amit CHOUDHARY, Bangalore (IN); Arzad KHERANI, Bangalore (IN)

(73) Assignee: Broadcom Corporation, Irvine, CA (US)

(21) Appl. No.: 14/139,378

(22) Filed: Dec. 23, 2013

(51) Int. Cl. H04W 16/14

(52) U.S. Cl. CPC H04W 16/14; H04W 88/06

(57) ABSTRACT

Example embodiments generally relate to adapting a reception via first wireless technology to reduce or avoid interference with a transmission via a second wireless technology. For example, a user equipment (e.g. cell phone) can include radios operating according to first and second wireless radio technologies, which can include Long Term Evolution (LTE) and a technology using the industrial, scientific and medical (ISM) frequency band. In this example, the LTE radio may adapt, delay, or avoid the reception of certain scheduled system information from the network to reduce or avoid interference with transmission from the ISM radio.

### BACKGROUND OF THE DISCLOSURE

1. Field of the Disclosure

Example embodiments generally relate to adapting a reception via first wireless technology to reduce or avoid interference with a transmission via a second wireless technology.

2. Background

A mobile device may be capable of communicating using more than one wireless technology. When operated concurrently, certain radio technologies within such a device may operate on frequencies that cause interference. For example, wireless communications conforming to the 3rd Generation Partnership Project's (3GPP) long-term evolution (LTE) specification may operate on frequencies near or adjacent to an industrial, scientific and medical (ISM) frequency band. So, interference may result between LTE communication and communication from a technology operating in the ISM band in a device that implements both technologies. To reduce or eliminate interference, co-existence coordination may be required to schedule transmission and reception among co-existing radio technologies, while avoiding performance degradation in the co-existing radio technologies.

### BRIEF DESCRIPTION OF THE DRAWINGS/FIGURES

FIG. 1 illustrates an example communications system, which includes an apparatus that is capable of communicating via more than one wireless technology.

FIG. 2 illustrates example frequency bands for wireless communications.

FIG. 3 illustrates an example apparatus that is capable of communicating via more than one wireless technology.

FIG. 4 illustrates an example message sequence chart of the transmission of system information from an LTE network to an LTE-enabled device.

FIG. 5 illustrates an example diagram of co-existence coordination between reception of LTE system information and ISM transmission.

FIG. 6 illustrates an example method for co-existence coordination between reception of LTE system information and ISM transmission.

FIG. 7 illustrates an example method applicable to certain aspects of FIG. 6.

FIG. 8 illustrates an example method applicable to certain aspects of FIG. 6.

FIG. 9 illustrates an example computer system for implementing one or more embodiments of the disclosure.

### DETAILED DESCRIPTION OF EXAMPLE EMBODIMENTS

While the present disclosure is described herein with illustrative embodiments for particular applications, it should be understood that the disclosure is not limited thereto. A person skilled in the art with access to the teachings provided herein will recognize additional modifications, applications, and embodiments within the scope thereof and additional fields in which the disclosure would be of significant utility.

The terms “embodiments” or “example embodiments” do not require that all embodiments include the discussed feature, advantage, or mode of operation. Alternate embodiments may be devised without departing from the scope or spirit of the disclosure, and well-known elements may not be described in detail or may be omitted so as not to obscure the relevant details. In addition, the terminology used herein is for the purpose of describing particular embodiments only and is not intended to be limiting. For example, as used herein, the singular forms “a,” “an” and “the” are intended to include the plural forms as well, unless the context clearly indicates otherwise. It will be further understood that the terms “comprises,” “comprising,” “includes” and “including,” when used herein, specify the presence of stated features, integers, steps, operations, elements, and components, but do not preclude the presence or addition of one or more other features, integers, steps, operations, elements, components, or groups thereof.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms may be utilized interchangeably in the subject specification and related drawings. Likewise, the terms “access point,” “base station,” “base transceiver station”, “Node B.” “evolved Node B (eNode B),” home Node B (HNB),” “home access point (HAP),” or the like, may be utilized interchangeably in the subject specification and drawings, and refer to a wireless network component or apparatus that serves and receives data, control, voice, video, sound, gaming, or substantially any data-stream or signaling-stream from a set of subscriber stations.

Software described throughout this disclosure may be embodied as one or more computer-readable instruction(s) on a computer-readable storage device that is tangible—such as a persistent memory device (e.g., read-only memory (ROM), flash memory, a magnetic storage device, an optical disc, and the like), a non-persistent memory device (e.g., random-access memory (RAM)), and the like—that can be executed by a processor to perform one or more operations.

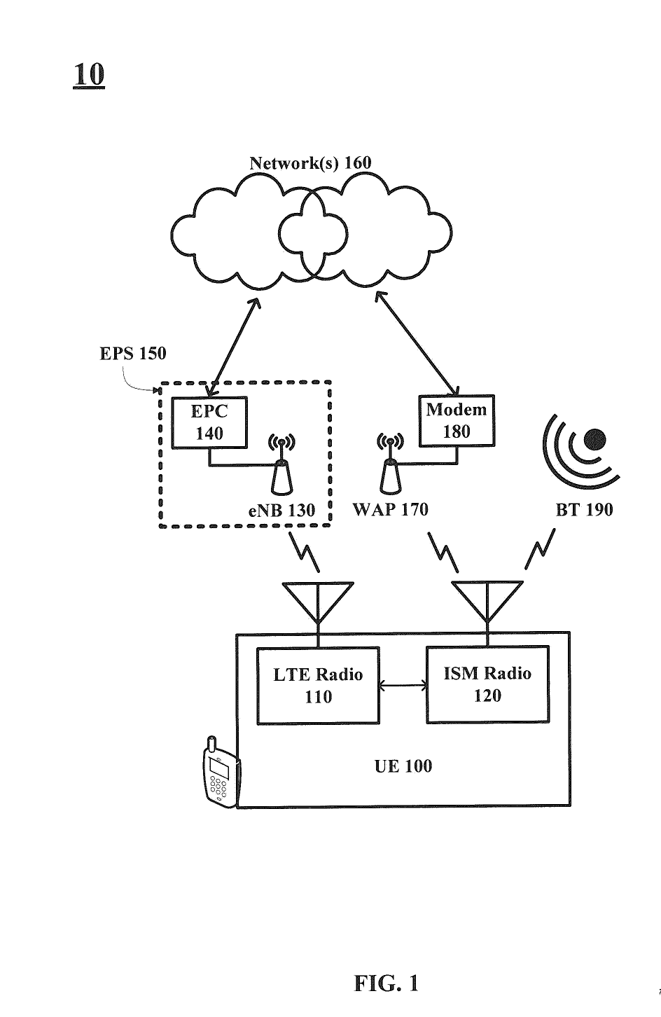

Turning now to FIG. 1, an example communications system 10, which includes an apparatus (UE 100) that is capable of communicating via more than one wireless technology, is shown. The user equipment (UE) 100 of FIG. 1 may be any device that that is capable of communicating via more than one wireless technology and supports co-existing wireless communications. Examples of the UE 100 include (but are not limited to) a mobile computing device—such as a laptop computer, a tablet computer, a mobile telephone or smartphone, a “phablet,” a personal digital assistant (PDA), and the like; a wearable computing device—such as a computerized wrist watch or “smart” watch, computerized eyeglasses, and the like; and a stationary computing device—such as a personal computer (PC), a desktop computer, a computerized kiosk, and the like.

As shown in FIG. 1, the UE 100 includes a radio transceiver that is configured for communications conforming to the 3GPP's LTE specification (i.e., LTE radio 110), and a radio transceiver that is configured for communications via a technology that operates over an industrial, scientific and medical (ISM) frequency band (i.e., ISM radio 120). The ISM radio 120 may implement any technology that operates in the ISM frequency band, such as (but not limited to) Wi-Fi (i.e., the Institute of Electrical and Electronics Engineers' (IEEE) 802.11 standards), Bluetooth, and the like. In one embodiment, the ISM radio 120 represents a device, integrated circuit, chip, etc., that implements more than one technology operating in the ISM frequency band, e.g., Wi-Fi and Bluetooth. While not shown, the UE 100 of FIG. 1 may include one or more additional radio transceivers. For example, the UE 100 may also include a radio transceiver that is configured for communications with a global navigation satellite system (GNSS), such as the global positioning system (GPS). Each radio transceiver of the UE 100 may be implemented in hardware, software, or any combination of hardware and software.

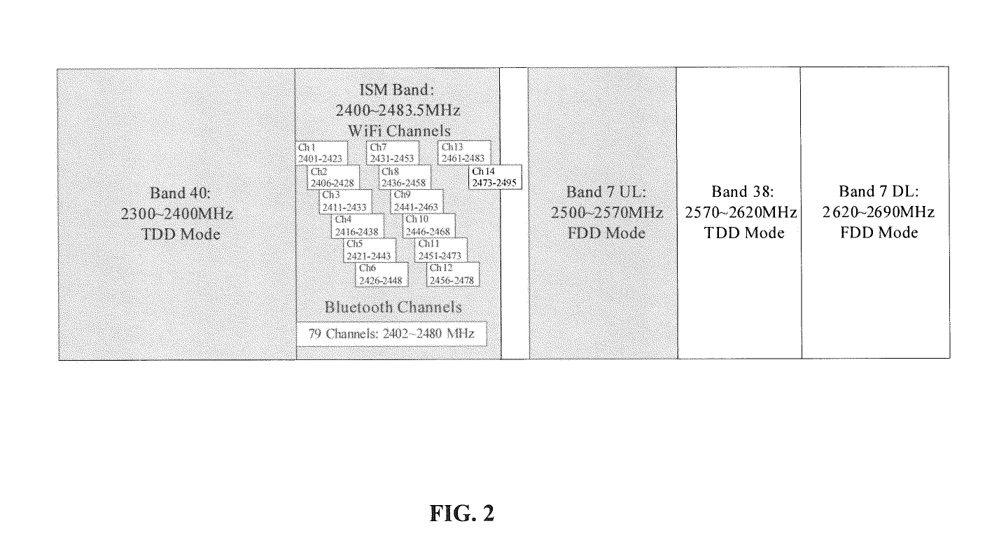

The LTE radio 110 and the ISM radio 120 may operate on adjacent or nearly adjacent frequencies. FIG. 2 illustrates this scenario—the LTE radio 110 may operate in “band 40” (23002400 MHz) and “band 7 UL” (2500-2570 MHz), and the ISM radio may operate in the 2400-2483.5 MHz frequency range. As shown in FIG. 2, Wi-Fi and Bluetooth may operate in the ISM radio band, adjacent or nearly adjacent to the LTE bands. In some situations, without co-existence coordination, concurrent operation of the LTE radio 110 and the ISM radio 120 may cause interference with each other.

Returning to FIG. 1, the LTE radio 110 supports communications with the evolved packet system (EPS) 150. The EPS 150 of FIG. 1 comprises an evolved packet core (EPC) 140 together with an evolved radio access network (evolved universal terrestrial radio access (E-UTRA) and evolved universal terrestrial radio access network (E-UTRAN)). The EPC 140 is the core network architecture of the LTE system, and is a packet-switched architecture that relies on Internet Protocol (IP) for transport services. The EPC 140 is connected to the external network 160, which may include one or more packet data networks (PDN), such as (but not limited to) an Internet protocol (IP) Multimedia Core Network Subsystem (IMS) and the Internet. In one example, the EPC 140 transports a voice over LTE (VoLTE) service provided by an IMS to the UE 100. In another example, the EPC 140 transports Email, video streaming, web browsing, and like services provided by the Internet to the UE 100.

The evolved radio access network of the EPS 150 of FIG. 1 includes the eNodeB (eNB) 130, which may be one of a plurality of base stations that are networked together to form the E-UTRAN. A person skilled in the art would understand that the EPS 150 is not limited to a single base station as illustrated in FIG. 1, but may include any number of eNBs. Additionally, while not shown, the EPS 150 may include one or more relay nodes or any other equipment associated with radio communications. Each eNB of the EPS 150, including the eNB 130, is connected to an EPC, such as EPC 140. The UE 100 illustrated in FIG. 1 may access (via the LTE radio 110) the eNB 130 to connect to the EPC 140. Because the EPC 140 is connected to the external network 160, the UE 100 can access services provided by the external network 160 through the EPS 150.

The ISM radio 120 may implement any technology, specification, or standard that operates in the ISM frequency band. In the example system 10 of FIG. 1, the ISM radio 120 may communicate with a wireless access point (WAP) 170, and/or a Bluetooth device (BT) 190. The WAP 170 may be associated with a wireless local area network (WLAN), and may implement Wi-Fi technology. The WAP 170 may be included in, or be communicatively connected to, a modem 180 or any other mechanism that allows the UE 100 to connect to and communicate with the external network 160 via the WAP 170. In the example system 10 of FIG. 1, Wi-Fi and Bluetooth may operate in the ISM frequency band (refer to FIG. 2).

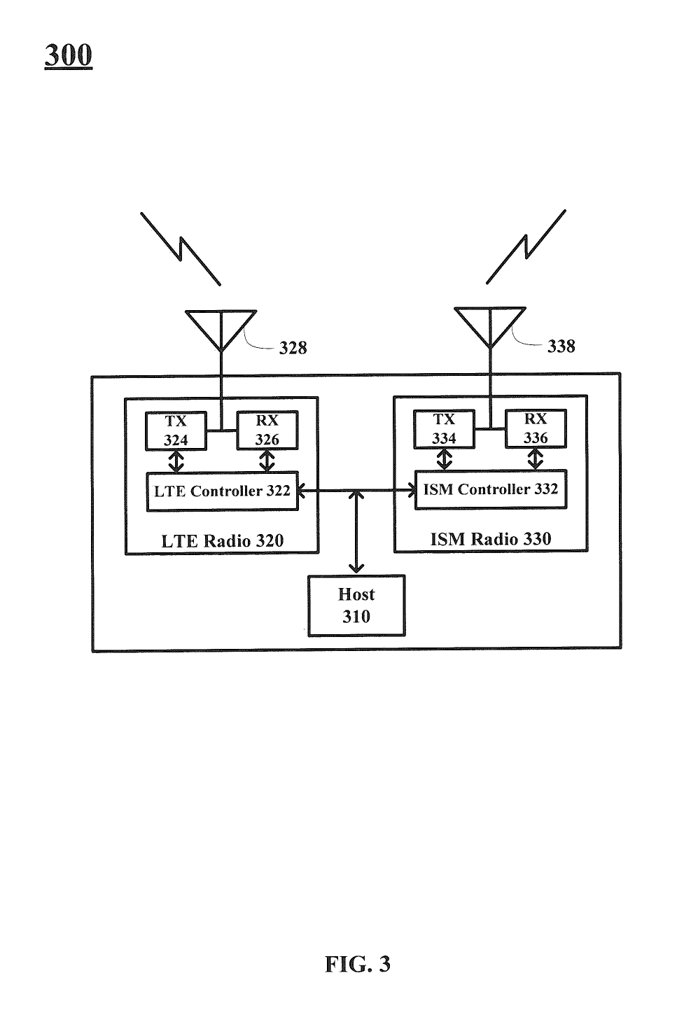

Turning to FIG. 3, an example apparatus 300 that is capable of communicating via more than one wireless technology is illustrated. The apparatus 300 can be a UE with two radios, and can be an example of UE 100. The apparatus 300 includes a host processor 310, an LTE radio 320, and an ISM radio 330. While only two radios are depicted in FIG. 3, the apparatus 300 may include more than two radios, as will be understood by those skilled in the arts. A person skilled in the art would understand that the apparatus 300 may include one or more components (e.g., implemented in hardware, software, or any combination of hardware and software) in addition to the components shown in the embodiment of FIG. 3 without departing from the scope of this disclosure. For example, the apparatus 300 may include an input device for accepting user input; an output device to present aural, visual, and/or tactile output; a memory system for storing data and executable code (e.g., one or more applications); a power source (e.g., a battery); various interfaces for connecting other devices (e.g., a peripheral device); and any other component known to a person skilled in the art.

Some or all of the components of the apparatus 300 may be implemented as a single integrated circuit, or may be implemented as different integrated circuits that are communicatively connected (e.g., via wires or wirelessly). In one example, the host 310, the LTE radio 320, and the ISM radio 330 are implemented as a single integrated circuit. In another example, the host 310, the LTE radio 320, and the ISM radio 330 are each implemented as separate integrated circuits. Separate integrated circuits may be mounted on a printed circuit board (PCB) along with other circuits, devices, components, and the like. Other configurations apparent to a person skilled in the art are within the scope of this disclosure.

The apparatus 300 of FIG. 3 may support co-existing wireless communications. Via the radios 320 and 330, the apparatus 300 may establish co-existing connections and concurrently communicate via more than one wireless technology. In one example, the LTE radio 320 exchanges communications over an EPS (e.g., EPS 150 of FIG. 1) while the ISM radio 330 exchanges communications with a Wi-Fi WAP (e.g., WAP 170 of FIG. 1). In another example, the LTE radio 320 exchanges communications over an EPS while the ISM radio 330 exchanges communications with a Bluetooth device (e.g., BT 190 of FIG. 1). In yet another example, the LTE radio 320 exchanges communications over an EPS while the ISM radio 330 exchanges communications with a Wi-Fi-enabled device and a Bluetooth-enabled device. Again, all other configurations apparent to a person skilled in the art are within the scope of this disclosure.

As mentioned, the apparatus 300 includes the host 310. The host 310 is communicatively connected to the LTE radio 220 and the ISM radio 230. The host 310 may control the overall operation of the apparatus 300, and may include (but is not limited to) one or more: central processing units (CPU), field programmable gate arrays (FPGA), application specific integrated circuits (ASIC), digital signal processors (DSP), and the like. The host 310 may execute one or more applications, such as an operating system (OS), to control the overall operation of the apparatus 300, and to manage co existing wireless connections in accordance with example embodiments of this disclosure. The host 310 may include one or more components (e.g., implemented in hardware, software, or any combination of hardware and software) in addition to the components shown in the embodiment of FIG. 3 without departing from the scope of this disclosure.

The LTE radio 320 includes an LTE controller 322, a transmitter (TX) 324, a receiver (RX) 326, and an antenna 328. The LTE controller 322 is communicatively connected to both of the TX 324 and the RX 326 for control and data transmission and reception. The LTE controller 322 is also communicatively connected to the ISM controller 332 of the ISM radio 330, and can exchange data or other communications with the ISM controller 332. The antenna 328, which transmits and receives electromagnetic radiation, is communicatively connected to both of the TX 324 and the RX 326. In FIG. 3, the antenna 328 may represent one or more antennas—e.g., the antenna 328 may represent a multiple-input and multiple-output (MIMO) structure. The TX 324 and RX 326 may include components such as oscillators, mixers, amplifiers and the like, that cause interference with transmissions to/from the ISM radio 330, when the interfering components are operating.

The LTE radio 320 may include one or more components (e.g., implemented in hardware, software, or any combination of hardware and software) in addition to the components shown in the embodiment of FIG. 3 without departing from the scope of this disclosure. Some or all of the components of the LTE radio 320 may be implemented as a single integrated circuit, or may be implemented as different integrated circuits that are communicatively connected (e.g., via wires or wirelessly). And one or more components of the apparatus 300, such as the LTE radio 320, may implement the protocol stack defined by the 3GPP's LTE specification to enable communication with an LTE network.

The ISM radio 330 includes an ISM controller 332, a transmitter (TX) 334, a receiver (RX) 336, and an antenna 338. The ISM controller 332 is communicatively connected to both of the TX 334 and the RX 336. The ISM controller 332 is also communicatively connected to the LTE controller 322 of the LTE radio 320, and can exchange data or other communications with the LTE controller 322. The antenna 338, which transmits and receives electromagnetic radiation, is communicatively connected to both of the TX 334 and the RX 336. In FIG. 3, the antenna 338 may represent one or more antennas—e.g., the antenna 338 may represent a multiple-input and multiple-output (MIMO) structure.

The ISM radio 330 may include one or more components (e.g., implemented in hardware, software, or any combination of hardware and software) in addition to the components shown in the embodiment of FIG. 3 without departing from the scope of this disclosure. And, some or all of the components of the ISM radio 330 may be implemented as a single integrated circuit, or may be implemented as different integrated circuits that are communicatively connected (e.g., via wires or wirelessly).

The apparatus 300, via the LTE radio 320, may be configured to receive system information from an LTE network (such as the EPS 150 of FIG. 1) that is in communication with the apparatus 300. Referring to the 3GPP's technical specification 3GPP TS 36331 v11.5.0 (2013-09), which is incorporated by reference in its entirety herein, LTE system information is divided into the MasterInformationBlock (MIB) and a number of SystemInformationBlocks (SIBs). The MIB includes a limited number of most essential and most frequently transmitted parameters that are needed to acquire other information from the cell, and is transmitted on Broadcast Channel (BCH).

Each SIB contains system information and is identified using the following nomenclature: SystemInformationBlockTypeN, where N is a whole number greater than zero. For example, SystemInformationBlockType1 (SIB1) contains information relevant when evaluating if a UE is allowed to access a cell and defines the scheduling of other system information; SystemInformationBlockType2 (SIB2) contains radio resource configuration information that is common for certain UEs; and so on. TABLE I below summarizes information contained in various SIBs specified in 3GPP's technical specification 3GPP TS 36.331 v11.5.0 (2013-09).

TABLE I

| SIB | Description |
|---|---|
| SystemInformationBlockType1 | Contains information relevant when evaluating if a |
| | UE is allowed to access a cell and defines the |
| | scheduling of other system information. |
| SystemInformationBlockType2 | Contains radio resource configuration information |
| | that is common for certain UEs. |
| SystemInformationBlockType3 | Contains cell re-selection information common for |
| | intra-frequency, inter-frequency and/or inter-Radio |
| | Access Technology (inter-RAT) cell re-selection |
| | (i.e., applicable for more than one type of cell re- |
| | selection but not necessarily all) as well as intra- |
| | frequency cell re-selection information other than |
| | neighboring cell related. |
| SystemInformationBlockType4 | Contains neighboring cell related information |
| | relevant for intra-frequency cell re-selection. |
| SystemInformationBlockType5 | Contains information relevant for inter-frequency |
| | cell re-selection, i.e., information about other |
| | E-UTRA frequencies and inter-frequency |
| | neighboring cells relevant for cell re-selection. |
| SystemInformationBlockType6 | Contains information relevant for inter-RAT cell re- |
| | selection, i.e., information about UTRA frequencies |
| | and UTRA neighboring cells relevant for cell re- |
| | selection. |
| SystemInformationBlockType7 | Contains information relevant for inter-RAT cell re- |
| | selection, i.e., information about GSM/EDGE Radio |
| | Access Network (GERAN) frequencies relevant for |
| | cell re-selection. |
| SystemInformationBlockType8 | Contains information relevant for inter-RAT cell re- |
| | selection, i.e., information about CDMA2000 |
| | frequencies and CDMA2000 neighboring cells |
| | relevant for cell re-selection. |
| SystemInformationBlockType9 | Contains a home eNB name (HNB Name). |
| SystemInformationBlockType10 | Contains an Earthquake and Tsunami Warning |
| | System (ETWS) primary notification. |
| SystemInformationBlockType11 | Contains an ETWS secondary notification. |
| SystemInformationBlockType12 | Contains a Commercial Mobile Alert Service |
| | (CMAS) notification. |
| SystemInformationBlockType13 | Contains the information required to acquire the |
| | Multimedia Broadcast Multicast Service (MBMS) |
| | control information associated with one or more |
| | Multimedia Broadcast multicast service Single |
| | Frequency Network (MBSFN) areas. |
| SystemInformationBlockType14 | Contains the Extended Access Barring (EAB) |
| | parameters. |
| SystemInformationBlockType15 | Contains the MBMS Service Area Identities (SAI) of |
| | the current and/or neighboring carrier frequencies. |
| SystemInformationBlockType16 | Contains information related to GPS time and |
| | Coordinated Universal Time (UTC). |

SIBs other than SystemInformationBlockType1 are carried in SystemInformation (SI) messages. The mapping of SIBs to SI messages is flexibly configurable by schedulingInfoList included in SystemInformationBlockType1, with restrictions that: each SIB is contained only in a single SI message, only SIBs having the same scheduling requirement (periodicity) can be mapped to the same SI message, and SystemInformationBlockType2 is always mapped to the SI message that corresponds to the first entry in the list of SI messages in schedulingInfoList. There may be multiple SI messages transmitted with the same periodicity.

SystemInformationBlockType1 and all SI messages may be transmitted on the Downlink Shared Channel (DL-SCH). Once SystemInformationBlockType1 has been received and decoded, the SI messages and their scheduling by the network is known. So, in this disclosure, scheduling information included in SystemInformationBlockType1 may be considered a “message transmission schedule.”

An LTE-enabled device, such as UE 100 of FIG. 1 or apparatus 300 of FIG. 3, may acquire the detailed time-domain scheduling (and other information, e.g., frequency-domain scheduling, used transport format) by decoding System Information-Radio Network Temporary Identifier (SI-RNTI) on the Physical Downlink Control Channel (PDCCH). A single SI-RNTI is used to address SystemInformationBlockType1 as well as all SI messages. And SystemInformationBlockType1 configures the SI-window length and the transmission periodicity for the SI messages.

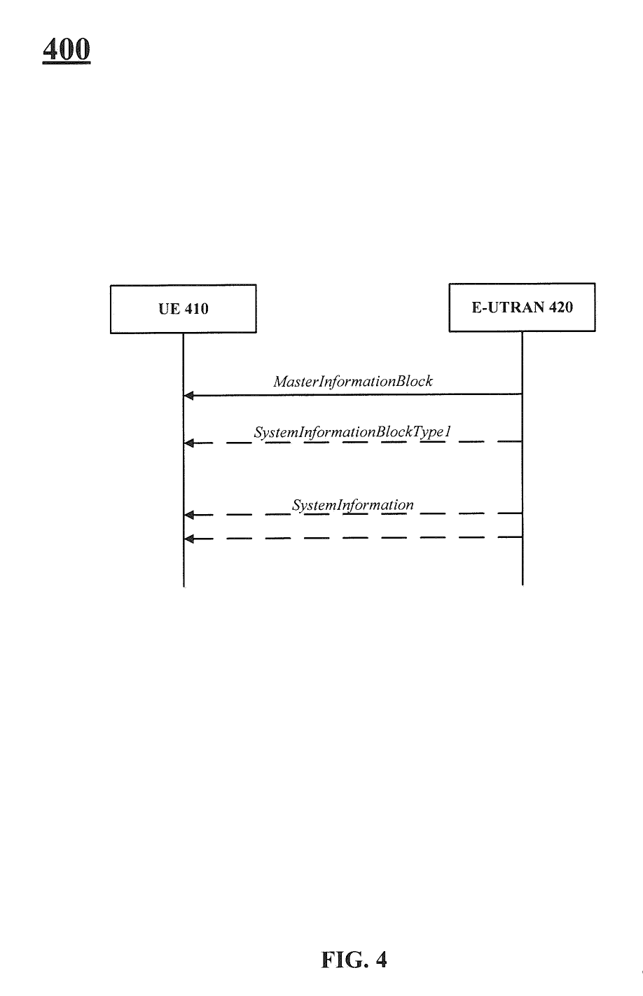

Turning briefly to FIG. 4, an example message sequence chart 400 illustrates the transmission of system information from an LTE network to an LIE-enabled device. As shown, an LTE-enabled UE 410, which may be UE 100 of FIG. 1 or apparatus 300 of FIG. 3, receives MasterInformationBlock, SystemInformationBlockType1, and other SystemInformation from an LTE network via E-UTRAN 420. The other SystemInformation shown in FIG. 4 may be SI messages carrying various SIBs in accordance with the description above and the 3GPP's LTE specification.

Example embodiments of this disclosure describe, among other things, systems, methods, and techniques for adapting an LTE reception in order to reduce or avoid interference with an ISM transmission. In one embodiment, an LTE-enabled device adapts the reception of system information provided by an LTE network (e.g., via E-UTRAN) to reduce or avoid interference with a concurrent, pending, scheduled, etc. ISM transmission. For example, the apparatus 300 may adapt a reception of system information by the LTE radio 320 to reduce or avoid interference with a transmission from the ISM radio 330. While adapting the reception of LTE system information is described throughout this disclosure, the methods and techniques described herein apply equally to the reception of any scheduled data, information, or communication at a first transceiver to achieve co-existence coordination with a second transceiver that implements different, potentially competing or interfering, technology than the first transceiver.

Various methods may be employed, alone or in combination, to achieve this co-existence coordination. In some embodiments, the LTE controller 322 or the host 310 may generally enable/disable reception of some or all communications at the LTE radio 320 to implement the various methods and achieve the co-existence coordination described throughout this disclosure. For example, the LTE controller 322 or the host 310 may specifically enable/disable reception of SI messages at the LTE radio 320, which may leave the LTE radio 320 available to receive other communications, while implementing one or more of the various methods. Also, each of the techniques described below may be implemented after receiving and decoding SystemInformationBlockType1, which indicates the SI messages that will be sent by the network and their scheduling (e.g., transmission frequency and periodicity).

A first example method, which may be referred to as “out-of-order” acquisition, may be implemented to acquire SI messages out-of-order to reduce the overall time required to receive system information. A default technique requires receiving the SI messages in order; but since SI messages may be scheduled with different transmission frequency and periodicity, in-order acquisition may require intentionally ignoring or failing to receive an available SI message. Thus, out-of-order acquisition may reduce the overall time required to receive scheduled SI messages by acquiring each SI message when available, rather than waiting for a particular message's “turn”, when part of a sequence of messages. As should be apparent to a person of ordinary skill in the art, “out-of-order” acquisition may become “in-order” acquisition when the SI messages are scheduled to be available in-order; thus, this technique may also be referred to as “when available” acquisition or the like.

The following example helps illustrate this first method. The apparatus 300 of FIG. 3 receives, via the LTE radio 320, SIB1 from an LTE network. The LTE controller 322 or the host 310 decodes SIB1 to acquire the SI message transmission schedule, which (in this example) indicates that four SI messages (SI_{first}, SI_{second}, SI_{third}, and SI_{fourth}) are scheduled for transmission from the network, where SI_{first}, SI_{second}, SI_{third}, and SI_{fourth} are scheduled for transmission with periodicity of 16, 32, 256, and 64 radio frames, respectively. (Herein, a “periodicity of n” means that the SI message is available once every “n” number of transmitted radio frames.) The default “in-order” acquisition technique may first acquire SI_{first}; followed by SI_{second}; but then intentionally ignore the transmission of SI_{fourth}, which may be available (more than once) before SI_{third} due to its periodicity of 64 radio frames, until SI_{third} is acquired; and then finally acquire SI_{fourth}. Thus, the default “in-order” acquisition technique may require more than 256 radio frames to acquire the four example SI messages.

By contrast, the “out-of-order” acquisition method allows the LTE radio 320 to acquire SI fourth when available, instead of waiting until SI_{third} has been acquired. Thus, the “out-of-order” or “when available” method may require no more than 256 radio frames to acquire the four example SI messages. In this example, SI message acquisition may or may not be enabled (e.g., the LTE radio 320 may or may not be “listening” for the SI messages) for the entire period required to acquire the four example SI messages. Either way, the “out-of-order” method illustrated in this example may effectively reduce the overall period of time that the reception of system information at the LTE radio 320 could potentially interfere with transmission from the ISM radio 330. For example, circuits in the LTE radio 320 that cause interference (such as oscillators, mixers, amplifiers and the like) could be powered down, or not used, thereby decreasing potential interference with transmissions to/from the ISM radio 330.

A second example method that may be implemented to acquire SI messages may be referred to as “need-based” acquisition. In this technique, SI message acquisition is enabled to receive a given SI message transmitted from an LTE network when (at least) the following criteria are satisfied: (1) the given SI message is pending acquisition (e.g., the given SI message contains new information or information that has yet to be acquired by the LTE-enabled device), and (2) the given SI message is scheduled for transmission from the LTE network. Enabling SI message acquisition (e.g., “listening” for an SI message) when these criteria are met, and alternatively disabling SI message acquisition (or not “listening” for an SI message) when these criteria are not met may reduce the cumulative amount of time in a given period an LTE-enabled device devotes to receiving system information from the LTE network.

The following example helps illustrate the “need-based” acquisition method. The apparatus 300 of FIG. 3 receives, via the LTE radio 320. SIB 1 from an LTE network. The LTE controller 322 or the host 310 decodes SIB1 to acquire the SI message transmission schedule, which (in this example) indicates that four SI messages (SI_{first}, SI_{second}, and SI_{fourth}) are scheduled for transmission from the network, where SI_{first}, SI_{second}, SI_{third}, and SI_{fourth} are scheduled for transmission with periodicity of 16, 32, 256, and 64 radio frames, respectively. In this example, the LTE radio 320 is enabled (e.g., by the LTE controller 322 or the host 310) for SI message acquisition when the “need-based” acquisition criteria are satisfied (e.g., the LTE radio 320 may “listen” for a given SI message when the “need-based” acquisition criteria are satisfied). So once the apparatus 300 has acquired, e.g., SI_{first} by enabling SI message acquisition at the scheduled time it may ignore the periodic re-transmission of SI_{first} that occurs at 16 radio frame intervals until, e.g., the network updates the information carried by SI_{first}. The same may be true for the other three example SI messages. As this example illustrates, implementing the “need-based” acquisition method may reduce the cumulative amount of time in given period that the LTE radio 320 is enabled to receive (e.g., “listens” for) SI messages. For example, circuits in the LTE radio 320 that cause interference (such as oscillators, mixers, amplifiers and the like) could be powered down, or not used, thereby decreasing potential interference with transmissions to/from the ISM radio 330.

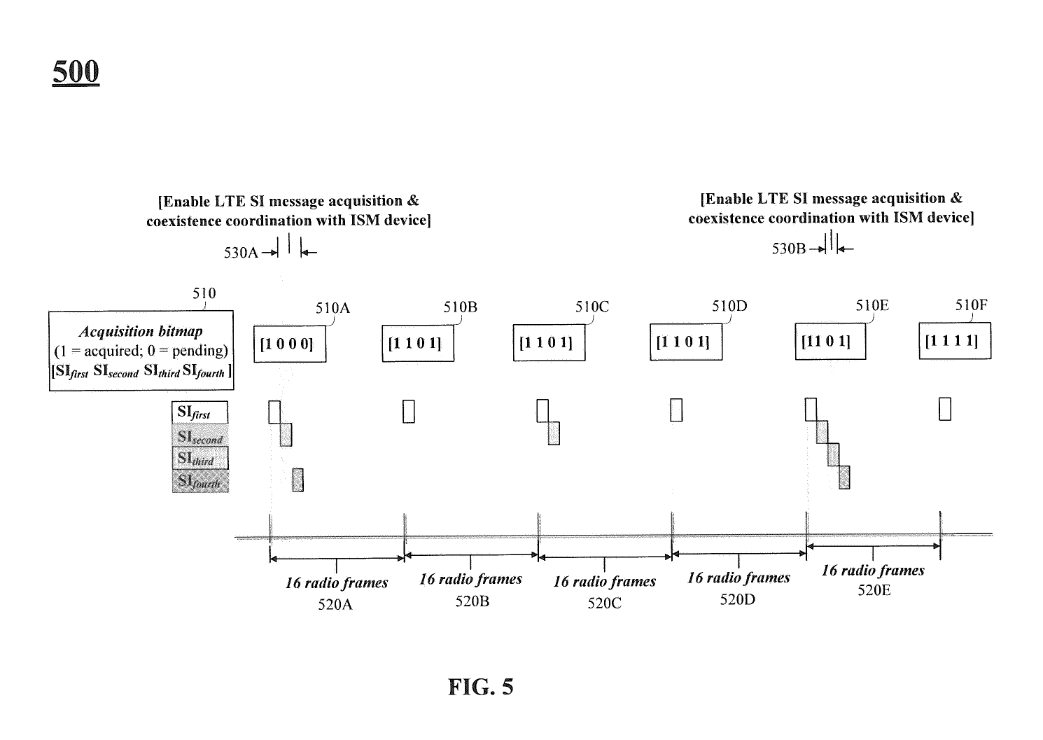

As mentioned, each of the methods described in this disclosure may be implemented alone or in combination with one or more of the other methods. So before describing a third method for co-existence coordination, the example diagram 500 of FIG. 5, which illustrates the implementation of both the “out-of-order” and “need-based” acquisition methods, is described. As in previous examples, the diagram 500 illustrates the scenario where an LTE-enabled device (e.g., the apparatus 300 of FIG. 3) receives (e.g., via the LTE radio 320) and decodes (e.g., via the LTE controller 322 or the host 310) SIB1 from an LTE network to acquire an SI message transmission schedule. In this scenario, the SI message transmission schedule indicates that four SI messages (SI_{first}, SI_{second}, SI_{third}, and SI_{fourth}) are scheduled for transmission from the network, where SI_{second}, SI_{third}, and SI_{fourth} are scheduled for transmission with periodicity of 16, 32, 256, and 64 radio frames, respectively. The transmission of SI_{first} with periodicity of 16 radio frames, SI_{second} with periodicity of 32 radio frames, and so on is illustrated in FIG. 5.

In FIG. 5, the acquisition bitmap key 510 explains the contents of acquisition bitmaps 510A-510F. As indicated by acquisition bitmap key 510, the acquisition of each of the four example SI messages is indicated by either a “1” or a “0,” where “1” indicates that the SI message has been acquired and “0” indicates that the SI message has not been acquired. So, for example, the acquisition bitmap 510A indicates that SI_{first} has been acquired, but SI_{second}, SI_{third}, and SI_{fourth} have not yet been acquired. Additionally, in the diagram 500. SI messages may be acquired during the acquisition windows 530A and 530B. For example, the LTE radio 320 may be enabled for SI message acquisition or “listening” for one or more SI messages during the acquisition windows 530A and 530B, and actively ignoring the SI messages outside the acquisition windows 530A and 530B. It is noted that the acquisition (time) windows 530A and 530B are a portion or subset of the bit maps 510A and 510E, which represent “data availability windows” because more SI messages are available than those actively selected by the acquisition windows 530A and 530B

During the first group of 16 radio frames 520A, SI_{first}, SI_{second}, and SI_{fourth} are available for acquisition, i.e., are scheduled to be transmitted from the LTE network. Since the acquisition bitmap 510A indicates that SI_{first} has already been acquired, SI message acquisition is not enabled to acquire SI_{first}—which illustrates the “need-based” acquisition method. But, since SI_{second} and SI_{fourth} are available and have yet to be acquired, SI message acquisition is enabled during the acquisition window 530A to acquire SI_{second} and SI_{fourth}. The acquisition of SI_{fourth} prior to acquiring SI_{third} (which is not available in this example until the fifth group of 16 radio frames 520E) illustrates the “out-of-order” or “when available” acquisition method.

The example diagram 500 of FIG. 5 illustrates that implementing the “out-of-order” and “need-based” acquisition methods may reduce the overall period of time and the cumulative amount of time in a given period that an LTE-enabled device is required to devote to the acquisition of system information from the LIE network. Here (FIG. 5), the LTE radio 320, e.g., only needs to “listen” for SI messages during the acquisition windows 530A and 530B to complete the acquisition of the four example SI messages. This, in turn, may reduce the occurrence of interference between SI message reception and ISM transmission from, e.g., ISM radio 330. For example, circuits in the LIE radio 320 that cause interference (such as oscillators, mixers, amplifiers and the like) could be powered down, or not used, thereby decreasing potential interference with transmissions to/from the ISM radio 330. As should be apparent to a person of skill in the art, FIG. 5 merely presents a non-limiting example to illustrate these methods for co-existence coordination.

Turning next to a third example method, which may be referred to as “elastic information” acquisition, the acquisition of elastic system information may be delayed. Elastic system information may be information that is not time sensitive, information that does not require immediate acquisition, information that is not considered “essential,” or the like. By contrast, inelastic system information may be information that is time sensitive, information that requires immediate acquisition, information that is considered “essential,” or the like. Examples of inelastic system information may include (but are not limited to) one or more of information in the MasterInformationBlock, information in the SystemInformationBlockType1, information in the SystemInformationBlockType2, ETWS notification in SystemInformationBlockType10, ETWS notification in SystemInformationBlockType11, CMAS notification in SystemInformationBlockType12 and the like. Refer to TABLE I above.

As mentioned, the acquisition of elastic system information may be delayed when the “elastic information” acquisition method is implemented. Once a given SI message is determined to be elastic—that is, the given SI message carries an SIB that contains elastic information—delayed reception of the given SI message may be triggered when a concurrent ISM transmission is scheduled. The acquisition of the given SI message may be delayed until the ISM transmission has completed or until a maximum delay threshold for acquiring the given SI message has been exceeded. Example maximum delay thresholds for the “elastic information” acquisition technique include (but are not limited to: 10 ms, 20 ms, 50 ms, 100 ms, and 200 ms, among others. In response to exceeding a maximum delay threshold, the given SI message may be acquired.

Considering the apparatus 300 as an example, during concurrent operation of the LTE radio 320 and the ISM radio 330, the ISM radio 330 may assert or request ISM transmission priority (ISM_TX_PRIORITY) when ISM transmission is scheduled. The terms “assert” and “request” may be used interchangeably throughout this disclosure—so “asserting” priority may function as “requesting” priority, and vice versa. ISM transmission priority may be de-asserted when the scheduled ISM transmission has completed. ISM transmission may be scheduled by the ISM radio 330 (e.g., via the ISM controller 332), the host 310, or another mechanism of the apparatus 300. And, ISM transmission priority may be asserted and de-asserted by the ISM radio 330 (e.g., via the ISM controller 332), the host 310, or another mechanism of the apparatus 300.

Continuing this example, the LTE radio 320 (e.g., via the LTE controller 322) may determine—e.g., by receiving a communication indicating assertion of ISM transmission priority; or by periodically polling the ISM radio 330, the host 310, or another mechanism (e.g., a flag register) of the apparatus 300—when ISM transmission priority has been asserted and when ISM transmission priority has been de-asserted. Once the LTE radio 320 determines that ISM transmission priority is asserted, it may adapt an SI message reception, under certain circumstances, to reduce or avoid interference with the scheduled ISM transmission. The ISM radio 330 (e.g., via the ISM controller 332), the host 310, or another mechanism may send a communication indicating the assertion of ISM transmission priority to the LTE radio 320 (e.g., to the LTE controller 322).

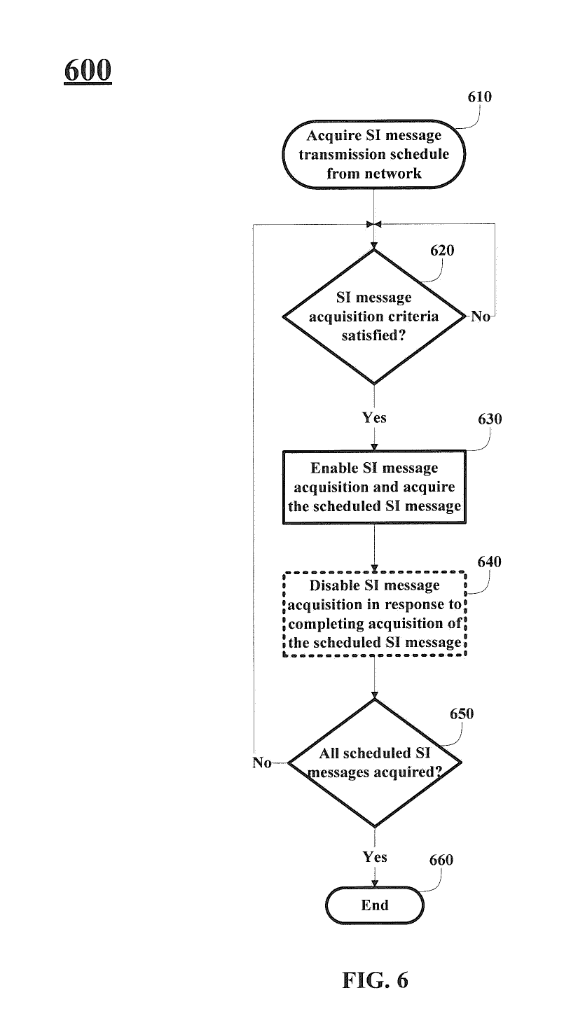

FIGS. 6, 7, and 8 illustrate example methods for adapting a reception via a first wireless technology to reduce or avoid interference with a transmission via a second wireless technology. These methods may be applicable to both time division duplex (TDD) and frequency division duplex (FDD). One, more than one, or all of these example methods may be implemented by any device or apparatus that is capable of communicating via more than one wireless technology, such as the UE 100 of FIG. I or the apparatus 300 of FIG. 3. Additionally, for each of the example methods, each stage of a method may represent a computer-readable instruction stored on a computer-readable storage device, which when executed by a processor causes the processor to perform one or more operations.

FIG. 6 illustrates an example method 600 for co-existence coordination between reception of LTE system information and ISM transmission. The method 600 of FIG. 6 may represent or be used to implement one or more of the “out-of-order” acquisition method, the “need-based” acquisition method, and the “elastic information” acquisition method. Some or all of the method 600 may be performed by an LTE radio (e.g., the LTE radio 320 including controller 322 of FIG. 3), a processor (e.g., the host 310 of FIG. 3), or a combination of components (e.g., an LTE radio and a processor). While the method 600 illustrates adapting reception of LTE system information to reduce or avoid interference with ISM transmission, it is not limited thereto. For example, the method 600 and may be implemented to adapt reception of any information, data, communications, etc. at any device or apparatus that is capable of communicating via more than one wireless technology, such as the UE 100 of FIG. 1 or the apparatus 300 of FIG. 3.

The method 600 begins at stage 610, where an SI message transmission schedule is acquired from an LTE network. For example, the apparatus 300 of FIG. 3 may receive, via the LTE radio 320, SIB1 from an LTE network. The LTE controller 322 or the host 310 may decode SIB1 to acquire the SI message transmission schedule. The method 600 proceeds to stage 620 once the SI message transmission schedule has been acquired.

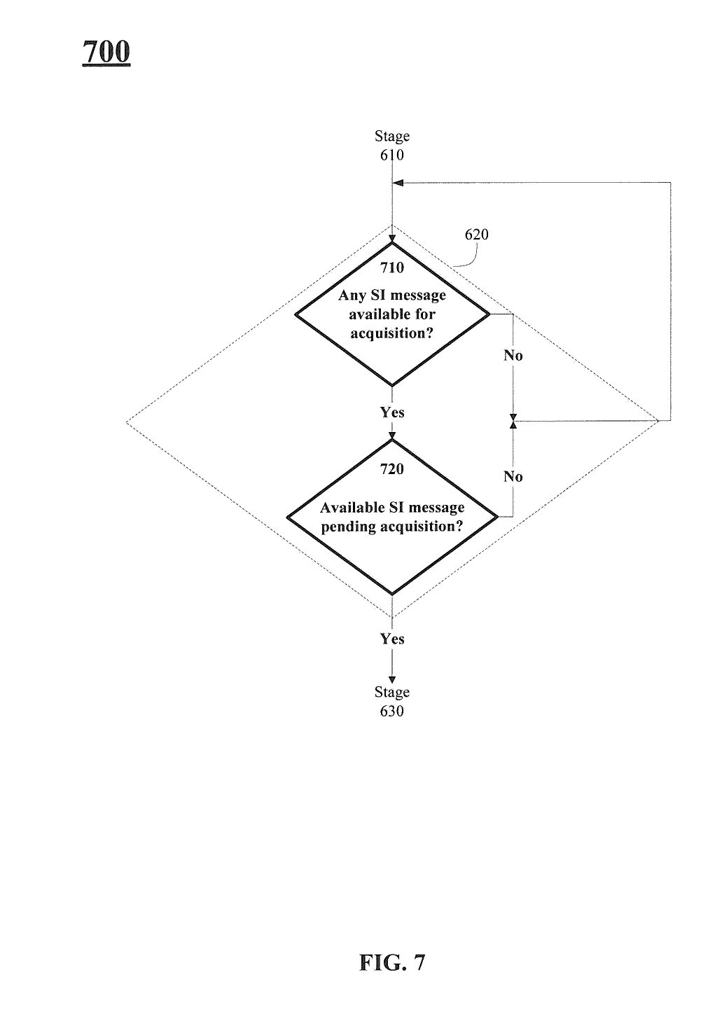

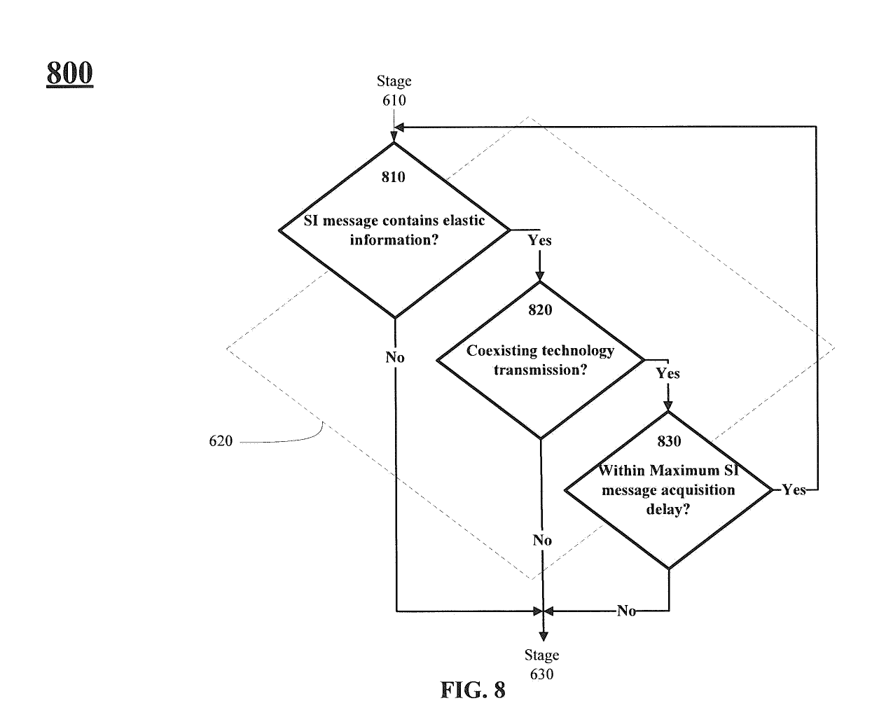

At stage 620, it is determined whether one or more SI message acquisition criteria are satisfied. SI message acquisition criteria may be associated with one or more of the “out-of-order,” the “need-based,” or the “elastic information” acquisition methods. In one example, the method 600 implements the “out-of-order” acquisition method, and the SI message acquisition criterion at stage 620 is whether an SI message is available (regardless of order) for acquisition. FIG. 7 illustrates an example of stage 620 where the method 600 implements both the “out-of-order” and “need-based” acquisition methods. FIG. 8 illustrates an example of stage 620 where the method 600 implements the “elastic information” acquisition method.

When the SI message acquisition criterion or criteria is satisfied at stage 620, the method advances to stage 630 where SI message acquisition is enabled and a scheduled SI message is acquired. As an example of stage 630, the LTE controller 322 or the host 310 may enable the LTE radio 320 to acquire an SI message during a message acquisition window (e.g., acquisition window 530A of FIG. 5). When the SI message acquisition criteria is not satisfied at stage 620, then LTE radio 320 may be disabled and control is returned to 620. Therefore, potentially interfering circuits (such as oscillators, mixers, amplifiers and the like) do not interfere with transmissions from ISM radio 330.

At stage 640, SI message acquisition may be disabled in response to completing acquisition of the scheduled SI message at stage 630. For example, LTE controller 322 or the host 310 may disable SI message acquisition at the LTE radio 320 (e.g., the LTE radio 320 may be disabled). Stage 640 may be optional—some of the methods and techniques described herein do not necessarily require disabling SI message acquisition in response to completing acquisition of a scheduled SI message. For example, the “out-of-order” acquisition method may enable SI message acquisition until all scheduled SI messages are acquired. Of course, as described above, the “out-of-order” acquisition method may alternatively disable SI message acquisition after each scheduled SI message is acquired.

Next, the method 600 advances to stage 650 where it is determined if all scheduled SI messages have been acquired. In the event that all scheduled SI messages have been acquired, the method 600 ends at stage 660. In the event that all scheduled SI messages have not been acquired, the method 600 returns to stage 620.

As mentioned, FIG. 7 illustrates an example method 700 for stage 620 of FIG. 6 when the method 600 implements both the “out-of-order” and “need-based” acquisition methods. The example method 700 may be implemented by one or more of the LTE controller 322, the host 310, or any other component of the apparatus 300. Turning to stage 710, it is determined whether any SI message is available for acquisition. If any SI message (regardless of order—“out-of-order” acquisition) is available for acquisition (i.e., the SI message is scheduled for transmission from the LTE network—criterion (2) of “need-based” acquisition), the method 700 advances to stage 720; otherwise the LTE radio 320 may be disabled and control is returned to stage 620.

At stage 720, it is determined whether the available SI message is pending acquisition (e.g., the available SI message contains new information or information that has yet to be acquired by the LTE-enabled device)—criterion (1) of “need-based” acquisition. When the available SI message is pending acquisition, the method 700 proceeds to stage 630; otherwise, e.g., the available SI message is a re-transmission carrying previously-acquired information, and the LTE radio 320 may be disabled and control is returned to stage 620. When the LTE radio 320 is disabled, the potentially interfering circuits (such as oscillators, mixers, amplifiers and the like) do not interfere with transmissions to/from the ISM radio 330.

FIG. 8 illustrates an example method 800 for stage 620 of FIG. 6 when the method 600 implements the “elastic information” acquisition method. The example method 800 may be implemented by one or more of the LTE controller 322, the host 310, the ISM controller 332, or any other component of the apparatus 300. Turning to stage 810, it is determined whether an available SI message contains elastic information. When the available SI message contains elastic information (Yes at stage 810), the method 800 advances to stage 820; otherwise (No at stage 820—that is, the available SI message contains inelastic information) the method 800 advances to stage 630 of FIG. 6.

At stage 820, it is determined whether a transmission from a device implementing a co-existing technology is scheduled concurrently with the scheduled acquisition of the available SI message. For example, stage 820 may determine whether an ISM transmission is scheduled concurrently with the scheduled acquisition of the available SI message. The apparatus 300 of FIG. 3 may implement stage 820 using the techniques described above for requesting or asserting ISM transmission priority. In the event that transmission from a co-existing technology is scheduled (Yes at stage 820), the method 800 proceeds to stage 830; otherwise (No at stage 820) the method 800 advances to stage 630 of FIG. 6.

At stage 830, it is determined whether the maximum SI message acquisition delay threshold has been exceeded. When the delay is within (e.g., less than or equal to) the maximum threshold (Yes at stage 830), then the LTE radio 320 may be disabled and control returns to stage 810; otherwise the method 800 advances to stage 630 of FIG. 6. In the method 800, advancing to stage 630 indicates that the SI message reception criteria of stage 620 are satisfied.

### Example Computer System

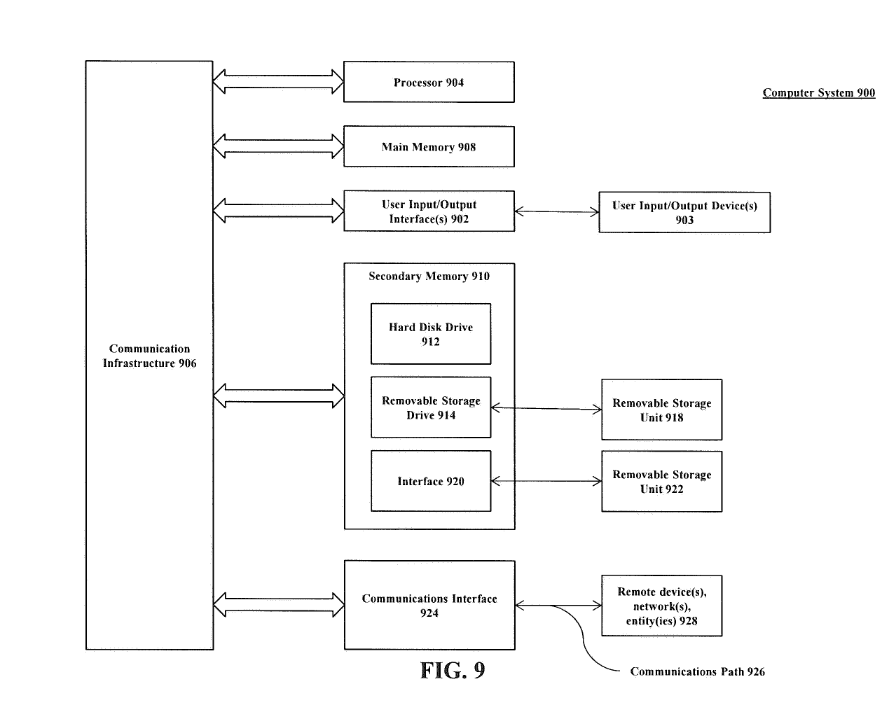

Various embodiments can be implemented, for example, using one or more well-known computer systems, such as computer system 900 shown in FIG. 9. For example, at least portions of the controllers 322, 332 and the host 310 can be implemented using all or portions of computer system 900, as well as for performing methods in FIGS. 6-8. Computer system 900 can be any well-known computer capable of performing the functions described herein, such as computers available from International Business Machines, Apple, Sun, HP, Dell, Sony, Toshiba, etc.

Computer system 900 includes one or more processors (also called central processing units, or CPUs), such as a processor 904. Processor 904 is connected to a communication infrastructure or bus 906.

One or more processors 904 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 900 also includes user input/output device(s) 903, such as monitors, keyboards, pointing devices, etc., which communicate with communication infrastructure xx06 through user input/output interface(s) xx02.

Computer system 900 also includes a main or primary memory 908, such as random access memory (RAM). Main memory 908 may include one or more levels of cache. Main memory 908 has stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to an exemplary embodiment, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

In an embodiment, a tangible apparatus or article of manufacture comprising a tangible computer useable or readable medium having control logic (software) stored thereon is also referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 9. In particular, embodiments may operate with software, hardware, and/or operating system implementations other than those described herein.

### CONCLUSION

The aforementioned description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the specification is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices and the like. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For purposes of this discussion, the term “module” and the like, shall be understood to include at least one of software, firmware, and hardware (such as one or more circuits, microchips, processors, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

What is claimed is:

1. An apparatus configured for wireless communication, the apparatus comprising:
a first radio configured to operate in at least a first frequency band and acquire a message transmission schedule from a network;
a second radio configured to operate in at least a second frequency band adjacent to the first frequency band; and
a controller configured to enable acquisition of a scheduled message designated by the message transmission schedule from the network by the first radio in response to an acquisition criterion being satisfied.

2. The apparatus of claim 1, wherein the first radio is further configured to acquire the scheduled message at a time designated by the message transmission schedule in response to the acquisition being enabled by the controller, and the controller is further configured to disable acquisition at the first radio in response to the first radio completing acquisition of the scheduled message.

3. The apparatus of claim 1, wherein the controller is further configured to determine that the acquisition criterion is satisfied in response to the scheduled message comprising information other than previously received information.

4. The apparatus of claim 1, wherein the controller is further configured to determine that the acquisition criterion is satisfied in response to the scheduled message comprising inelastic information.

5. The apparatus of claim 1, wherein the controller is further configured to determine that the acquisition criterion is satisfied in response to the second radio not being scheduled for transmission at a time designated by the message transmission schedule for transmission of the scheduled message from the network.

6. The apparatus of claim 1, wherein the controller is further configured to determine that the acquisition criterion is satisfied in response to exceeding an acquisition delay threshold of the first radio.

7. The apparatus of claim 1, wherein the first radio is configured to operate in compliance with one or more long-term evolution (LTE) specifications.

8. The apparatus of claim 1, wherein the second radio is configured to operate in, at least an industrial, scientific and medical (ISM) frequency band.

9. A method to reduce interference in an apparatus configured for wireless communication, the method comprising:
acquiring, by a radio configured to operate in at least a frequency band, a message transmission schedule from a network;
determining, by a controller disposed in the apparatus, whether an acquisition criterion for acquiring a scheduled message designated in the message transmission schedule by the radio is satisfied; and
enabling acquisition, by the radio, of the scheduled message from the network in response to determining the acquisition criterion is satisfied.

10. The method of claim 9, further comprising:
acquiring, by the radio, the scheduled message at a time designated by the message transmission schedule in response to enabling the radio to acquire the scheduled message; and
disabling acquisition by the radio in response to completing acquisition of the scheduled message.

11. The method of claim 9, wherein the determining whether the acquisition criterion is satisfied comprises:
determining that the acquisition criterion is satisfied in response to the scheduled message comprising information other than previously acquired information.

12. The method of claim 9, wherein the determining whether the acquisition criterion is satisfied comprises:
determining that the acquisition criterion is satisfied in response to the scheduled message comprising inelastic information.

13. The method of claim 9, wherein the determining whether the acquisition criterion is satisfied comprises:
determining that the acquisition criterion is satisfied in response to another radio, configured to operate in at least another frequency band adjacent to the frequency band, not being scheduled for transmission at a time designated by the message transmission schedule for transmission of the scheduled message from the network.

14. The method of claim 9, wherein determining whether the acquisition criterion is satisfied comprises:
determining that the acquisition criterion is satisfied in response to exceeding an acquisition delay threshold of the radio.

15. A non-transitory computer-readable medium comprising computer-readable instructions, which when executed by a controller cause the controller to perform operations comprising:
acquiring, by a radio configured to operate in at least a frequency band, a message transmission schedule from a network;
determining, by a controller disposed in the apparatus, whether an acquisition criterion for acquiring a scheduled message designated in the message transmission schedule by the radio is satisfied; and
enabling acquisition, by the radio, of the scheduled message from the network in response to determining the acquisition criterion is satisfied.

16. The non-transitory computer-readable medium of claim 15, the operations further comprising:
acquiring, by the radio, the scheduled message at a time designated by the message transmission schedule in response to enabling the radio to acquire the scheduled message; and
disabling acquisition by the radio in response to completing acquisition of the scheduled message.

17. The non-transitory computer-readable medium of claim 15, the operations further comprising:
determining that the acquisition criterion is satisfied in response to the scheduled message comprising information other than previously acquired information.

18. The non-transitory computer-readable medium of claim 15, the operations further comprising:
determining that the acquisition criterion is satisfied in response to the scheduled message comprising inelastic information.

19. The non-transitory computer-readable medium of claim 15, the operations further comprising:
determining that the acquisition criterion is satisfied in response to another radio, configured to operate in at least another frequency band adjacent to the frequency band, not being scheduled for transmission at a time designated by the message transmission schedule for transmission of the scheduled message from the network.

20. The non-transitory computer-readable medium of claim 15, the operations further comprising:
determining that the acquisition criterion is satisfied in response to exceeding an acquisition delay threshold of the radio.
